(19) United States
(12) Patent Application Publication
(10) Pub. No.: US 2023/0254595 A1
(43) Pub. Date: Aug. 10, 2023

(54) Optimal color filter array and a demosaicing method thereof

(71) Applicant: Shantanu Singh, Ghaziabad (IN)

(72) Inventor: Shantanu Singh, Ghaziabad (IN)

(73) Assignee: Shantanu Singh, Ghaziabad (IN)

(21) Appl. No.: 18/119,283

(22) Filed: Mar. 9, 2023

(30) Foreign Application Priority Data
Feb. 13, 2023 (IN) 202311009274

(51) Int. Cl. H04N 23/84; H04N 23/16; H04N 25/13

(52) U.S. Cl. CPC H04N 23/843; H04N 23/16; H04N 25/13

(57) ABSTRACT

A method for capturing raw digital color image data by an image sensor array that includes a color filter array (CFA), at least one type of color filter elements of which transmits an additive (or subtractive) mixture of plural color-components of an additive (or subtractive) color-space, unlike conventional CFAs (akin to the color filter array) wherein single color-component of the color-space passes through each color filter element. An image demosaicing method is disclosed to convert the raw digital color image data wherein each pixel has a raw grayscale value into a full-color image wherein each pixel has values in all color-channels of the color-space. Further, a method of optimizing relationship between low-light sensitivity of the image sensor array, effective resolutions of color-component images, of color-components of the color-space, that are associated with the raw digital color image data and color depth of the full-color image, by means of adjusting spectral transmission characteristics of different types of color filter elements forming the CFA is disclosed.

### CROSS-REFERENCE TO RELATED APPLICATIONS

The present non-provisional patent application claims the benefit of foreign priority to copending Indian non-provisional patent application Ser. No. 202311009274, filed on Feb. 13, 2023, entitled “OPTIMAL COLOR FILTER ARRAY AND A DEMOSAICING METHOD THEREOF”, the complete disclosure of which is expressly incorporated herein by reference in its entirety for all purposes.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable

### BACKGROUND OF THE INVENTION

### Field of the Invention

The invention generally relates to digital imaging devices and, more particularly, but not exclusively, to color filter arrays for use in color image sensors, and demosaicing methods for processing raw image data obtained from a color image sensor of a digital imaging device.

### Description of the Related Art Including Information Disclosed Under 37 CFR 1.97 and 37 CFR 1.98

Typically, image sensors comprise a planar array of solid-state light-sensitive units (photodetector elements) and a color filter array (CFA) is typically fabricated on the array of photodetector elements to capture color information, wherein color filter elements in the CFA are often arranged in a regular pattern of minimal repeating units, in which case different color filter elements corresponds to different color-channels.

Virtually all existing digital camera modules with an image sensor array that includes a CFA, for example, the traditional RGB Bayer CFA, can only capture one of three primary colors in each photosite in the image sensor array and so they discard roughly two-thirds of incoming light. This has always been a fundamental problem in CFA designs which is unavoidable due to the pixel masking and whose goal is to improve low-light sensitivity of a color image sensor by reducing portion of incident light unused by the CFA.

Image demosaicing, also color reconstruction, is an image processing stage to convert raw digital color image data received from an image sensor array into full color RGB data by interpolation. However, solid-state imaging array available in digital color cameras is a grayscale sensor that is not capable of detecting different colors. To enable color images to be captured, a CFA is overlaid on the sensor array. The CFA is a grid of color filters overlaying photodetector elements of the sensor array so that each sensor photodetector element receives light associated with a single color-component of a color-space. In this way a mosaiced-image is captured wherein each pixel has a intensity value for one of plural color-channels (Red, Green and Blue for example). Demosaicing is a process whereby intensity values for the other two channels are estimated from neighbouring pixel values for each of the pixels. However, demosaicing does not specifically address fundamental undersampling in typical camera designs and demosaiced color images frequently exhibit color aliasing artifacts (distortion).

Generally, Bayer CFAs are considered to be an industry standard. The CFAs use a mosaic pattern of two parts Green, one part Red, and one part Blue to interpret color information arriving at image sensor array. Typically, each of color filter elements in the CFAs corresponds to single image sensor pixel cell. However, Pixel binning is an image sensor technology wherein clusters of adjacent pixels are grouped together, or binned, to form larger superpixels, for example, Quad Bayer structure means four adjacent photodetector elements are clustered with the same-color filters. This binning occurs before the output of the superpixel is converted to digital information and can provide better low-light performance at the expense of some image resolution.

A color imaging device that includes a CFA superposed in registration with a solid-state sensor array for capturing color information, taking the Bayer CFA pattern as an embodiment example, is disclosed in U.S. Pat. No. 3,971,065A to Bayer; a color filter array and a demosaicing method similar to that described later herein are discussed earlier in International Application No. PCT/IN2022/050667 (published as WO 2022/185345 A2 and WO 2022/185345 A4), the International Search Report of which is published as WO 2022/185345 A3.

Furthermore detailed background information related to various aspects and techniques of color demosaicing process are discussed in Gunturk, B. K., Glotzbach, J., Altunbasak, Y., Schafer, R. W., Mersereau, R. M. (2005). Demosaicking: color filter array interpolation. IEEE Signal processing magazine, 22(1), 44-54.; and general state of the art is described in Lu, Y. M., Fredembach, C., Vetterli, M., Süsstrunk, S. (2009, November). Designing color filter arrays for the joint capture of visible and near-infrared images. In 2009 16th IEEE International Conference on Image Processing (ICIP) (pp. 3797-3800). IEEE..

### SUMMARY OF THE INVENTION

An object of this invention is to present a method of designing color filter arrays (CFAs) so as to capture color information at a lower expense of intensity of incoming light than CFAs used in conventional camera modules. Method presented herein allows for determination of transmission characteristic of each of different (types of) color filter elements in a CFA so as to transmit maximum intensity of light for desired spectral responses of a camera module that is associated with the CFA, thereby enhancing low-light sensitivity of the image sensor of the camera module.

The presented method includes single solid-state sensor array of photodetector elements of broad wavelength sensitivity superposed with a mosaic pattern CFA, color filter elements of which are arranged in one-to-one registration with elements of the sensor array. The color filter elements of the mosaic pattern CFA transmit additive (or subtractive) mixtures of plural color-components of a color-space so as to enable photosite pixels of raw digital color image data to effectively store intensity values in plural color-channels of the color-space, which is unlike most conventional CFAs (akin to the mosaic pattern CFA) wherein each pixel in raw digital color image data stores intensity value in single color-channel of the color-space. The raw digital color image data captured by the image sensor array that includes the mosaic pattern CFA may be deemed an array of pixel values of superposition of plural color-component images of color-components of the color-space instead of discrete arrays of pixel values, each indicating a raw intensity of one of the color-components as in case of conventional CFAs, and thereby the mosaic pattern CFA generates raw image data with relatively high effective resolutions of the color-component images than the latter.

It is a further object of invention to present a method of optimizing pattern of CFA of a color image sensor in a camera module, wherein color information associated with raw digital color image data, that is captured by the color image sensor, comprises superposition of color informations of color-channels of an output color-space so as to maximize effective resolutions of color-component images, and minimize aliasing and light loss to color filter array in final demosaiced full-color image by virtue of transmitting an additive (or subtractive) mixture of plural color-components of the output color-space for each of different (types of) color filter elements in the CFA, thus effectively reducing total number of missing color-component values in pixels of the raw digital color image data. This is in contrast to color image sensors used in conventional camera modules wherein low-light sensitivity and effective resolutions of color-component images are intrinsic characteristics of pattern of conventional CFA that is used in the color image sensors, and therefore cannot be adjusted. Since each of the color-components is partially measured at plural photosites in every photosite group of the color image sensor associated with the pattern of CFA, final color-component values obtained after demosaicing are effectively weighted averages of respective partial color-component values measured at plural pixel locations of the photosite group, thereby offering more color accuracy in final full-color image than when each of the color-components is measured at single pixel location, and then interpolated for neighboring pixels. Thus presented method for designing CFAs remedies the problem of undersampling that is fundamental in typical digital color cameras.

The disclosure also describes, inter alia, a demosaicing method, adapted to reconstruct a full color image from color information obtained by using the above described color image sensor. Raw image pattern obtained from the color image sensor is represented as a system of linear equations in N variables, wherein N is number of color-components of the output color-space that is associated with the image sensor array. The demosaicing method, for each of photosite pixels represented in the raw image pattern, calculates a new value for particular pixel in raw image pattern by passing pixel values of all pixels in the raw image pattern through an algorithm.

In one example, an improved version of the traditional RGB Bayer filter pattern is provided. A special feature of this CFA pattern is that each of three different (types of) color filter elements in the CFA pattern transmits an additive mixture of three RGB colors, unlike Bayer filter pattern that transmits a single component of RGB colors for each of the color filter elements. A special demosaicing method for reconstructing input raw pixel values to corresponding output RGB color values is also provided. The presented method can easily be generalized to all known CFA patterns and may also be applied in further researches.

The centrepiece of presently invented CFA pattern is that the constituent color filter elements can be made by cutting from sheets or plates of associated absorptive color-filters (for example, color compensation (CC) filters), wherein color of transmitted light is principally controlled by attenuating different amounts of Red, Green and Blue parts of the incident light spectrum, and can be used singly or in combination to build up a desired complex spectral transmission characteristic, and which can be manufactured at no extra cost and complexity in the same way as conventional Bayer CFA in a variety of ways, typically by depositing multi-layered thin film coatings onto a substrate using vacuum deposition, among other options such as dyed glass, lacquered gelatin, synthetic polymer filters and body-colored polycarbonate; the associated demosaicing method is simply computer-implementable.

### BRIEF DESCRIPTION OF DRAWINGS

The invention is described with reference to the accompanying drawings, wherein:

FIG. 1 depicts a two-dimensional plot of spectral transmittance curves of different (types of) color filter elements forming ideal Bayer CFA pattern, wherein transmittance [symbol] of the color filter elements is plotted along y-axis against wavelength in nanometres λ on x-axis, and wherein spectral transmittance curves R, G and B of three different band-pass optical filters of the RGB color filter element group are assumed to be sin³((0.0125(x-450))°):[450,700]→[0,1], sin²((0.0125(x-400))°):[400,650]→[0,1] and sin²((0.02(x-380))°):[380,535]→[0,1] respectively, in order to ease calculations and are merely illustrative;

FIG. 2 depicts a two-dimensional plot of tentative and actual spectral transmission characteristic of ideal color filter element F_{1,2} according to the present invention, wherein transmittance [symbol] of the color filter element is plotted along y-axis against wavelength in nanometres λ on x-axis.

### DETAILED DESCRIPTION OF THE INVENTION

In general, a photosite is mathematically representable by matrix equation

$$\text{ζ} \left({C}_{1 \times N}\right) ⋅ {F}_{N \times 1} = {G}_{1 \times 1}$$

, wherein matrices

$${C}_{1 \times N} ∈ \left\{\left[\begin{matrix}{v}_{{c}_{1}} & … & {v}_{{c}_{N}}\end{matrix}\right] : {v}_{{c}_{k \leq N}} ∈ {ℝ}_{\geq 0} , k ∈ ℕ\right\} ,$$

$$\begin{matrix}{F}_{N \times 1} ∈ \left\{\left[\begin{matrix}{\text{τ}}^{{c}_{1}} \\ … \\ {\text{τ}}^{{c}_{N}}\end{matrix}\right] : {\text{τ}}^{{c}_{k \leq N}} ∈ {ℝ}_{\leq 1}^{+} ∪ \left\{0\right\} , k ∈ ℕ\right\} \text{and} \\ {G}_{1 \times 1} ∈ \left\{\left[s\right] : s ∈ {ℤ}_{\geq 0}\right\}\end{matrix}$$

store incident light as intensities v_{c₁},..., v_{cN} of different color-components C₁,..., C_{N} of an output color-space, maximum values τ^{C¹},..., τ^{CN} of (perhaps overlapping) light transmittances of the color-components for the color filter element and a raw grayscale value s that is measured by a photodetector (light-sensitive) element, underlying the color filter element, that is associated with the photosite, respectively; ζ() is a quantization function for converting input original image data to quantized image data. In other words, the color filter element selectively transmits towards the photodetector element, light of a color-component, that is

$$\left[\begin{matrix}{c}_{1} & … & {c}_{N}\end{matrix}\right] ⋅ \left[\begin{matrix}{\text{τ}}^{{c}_{1}} \\ … \\ {\text{τ}}^{{c}_{N}}\end{matrix}\right] ,$$

of a raw color-space derived through conversion from the output color-space. Since each photodetector element produces an electrical charge that is directly proportional to light intensity it receives with no wavelength specificity, v_{c₁}, ..., v_{cN} are independent variables.

Inductively, a photosite group that is associated with a minimal repeating unit comprising an a × b set of individual color filter elements, under assumption that light intensities, that is C_{1×N}, of c₁, ...,c_{N} that are incident on each of the color filter elements are uniform, may be expressed by matrix equation

$${\text{ξ}}_{a \times a} ⋅ {P}_{a \times b} = {R}_{a \times b}$$

, wherein ξ_{a×a} = diag(ξ(C_{1×N}),...,ζ(C_{1×N})), and matrices P_{a×b} and R_{a×b} store maximum values of (perhaps overlapping) light transmittances of c₁,...,c_{N} for the color filter elements and raw grayscale values of color-components of the raw color-space that are measured by a photodetector group, underlying the minimal repeating unit, that is associated with the photosite group, respectively, and wherein P_{a×b}[i,j]=F_{i,j} (defined as

$$\left({F}_{i , j} = \left[\begin{matrix}{\text{τ}}_{i , j}^{{c}_{1}} \\ ⋯ \\ {\text{τ}}_{i , j}^{{c}_{N}}\end{matrix}\right]\right)$$

) wherein F_{i,j} ∈ {F_{N×1}} store maximum values of the light transmittances of c₁,...,c_{N} for a color filter element, that corresponds to a color-component

$$\left[\begin{matrix}{c}_{1} & … & {c}_{N}\end{matrix}\right] ⋅ \left[\begin{matrix}{\text{τ}}_{i , j}^{{c}_{1}} \\ ⋯ \\ {\text{τ}}_{i , j}^{{c}_{N}}\end{matrix}\right]$$

of the raw color-space, at pixel location (i, j) in the minimal repeating unit, and R_{a×b}[i,j] = G_{i,j} wherein G_{i,j} ∈ {G_{1×1}} stores raw grayscale value that is measured by a photodetector element that is associated with the color filter element at pixel location (i,j) in the minimal repeating unit. diag(e,...,e) denotes diagonal matrix wherein all diagonal entries are equal to e, and M[r,c] denotes the entry in r-th row and c-th column of a matrix M. Clearly,

$${\text{ξ}}_{a \times a} = {R}_{a \times b} ⋅ {P}_{a \times b}^{- 1}$$

represents solution of the matrix Equation (1), wherein matrix R_{a×b} represents an input raw image pattern, that is associated with the raw color-space, before transformation and matrix ξ_{a×a} represents output color pixel data, that is associated with the output color-space, after transformation, and therefore, precomputing the color-space transform matrix

$${P}_{a \times b}^{- 1}$$

greatly reduces computational time complexity of the above color conversion method.

Note that C_{1×n} may also be deemed as variable matrix representing color information about the raw image pattern R_{a×b,} that can be closely determined as ζ(C_{1×N}) by using a color conversion method that requires solving of matrix Equation (1) for ξ_{a×a} under condition that total number of unique color filter elements F_{i,j} (each representing an independent linear equation) constituting P_{a×b} is equal to or greater than N (that is total number of unknown variables v_{Cₖ} in C_{1×N}), and then diagonalizing ξ_{a×a,} if necessary, to obtain a diagonal matrix Ω_{a×a} which best approximates ξ_{a×a}. Virtually, the assumption that incident light intensity over each of color filter elements in P_{a×b} is uniform is not always true, thus all the diagonal elements of Ω_{a×a} are not always equal. Therefore, more practically, ζ(C_{1×N}) can be approximated as average of the diagonal elements of Ω_{a×a}, that is

$$\text{ζ} \left({C}_{1 \times N}\right) \approx \frac{{\sum }_{n = 1}^{a} {\text{Ω}}_{a \times a} \left[n , n\right]}{a} .$$

Thereafter, a full-color image can be obtained by applying any known demosaicing method to R_{a×b}, after performing image transform that is defined by conditional expression:

$$\left({\text{τ}}_{i , j}^{{c}_{k}} = max \left({\text{τ}}_{1 , 1}^{{c}_{k}} , ⋯ , {\text{τ}}_{a , b}^{{c}_{k}}\right)\right) ⇔ \left({R}_{a \times b} \left[i , j\right] = \left[{v}_{{c}_{k}}\right]\right) ∀ i , j , k$$

, wherein max(N₁,...,Nₙ) denotes the largest value in the set of values N₁, ..., Nₙ. Hereinafter, the latter is illustrated in more detail, by way of example, in paragraph [0025].

Optimal ideal color filter pattern P_{a×b} with respect to a conventional CFA pattern can be formulated via computational optimization methods by substituting spectral transmittances of color filter elements of the conventional CFA pattern into matrix C_{1×N} (C_{1×3} = [R G B] for example, wherein R, G and B are spectral transmittances of color filter elements forming the ideal Bayer color filter array); then solving equation

$${\sum }_{i = 1}^{a} {\sum }_{j = 1}^{b} {F}_{i , j}^{\text{T}} ⋅ \text{diag} \left({C}_{1 \times N}\right) = μ ⋅ {D}_{1 \times N}$$

for maximum values

$${\text{τ}}_{1 , 1}^{{c}_{1}} , ⋯ , {\text{τ}}_{a , b}^{{c}_{N}}$$

of (perhaps overlapping) light transmittances of color-components c₁,...,c_{N} of a color-space that is associated with the conventional CFA pattern

$$\left({\text{τ}}_{i , j}^{R} , {\text{τ}}_{i , j}^{G} \text{and} {\text{τ}}_{i , j}^{B}\right)$$

for example, since the conventional ideal Bayer CFA pattern is associated with a RGB color-space) for ideal color filter elements F_{1,1},...,F_{a,b} constituting P_{a×b} to maximize µ∈ℝ⁺, wherein

$${F}_{i , j}^{\text{T}}$$

is transpose of matrix F_{i,j}, diagonal matrix diag(C_{1×N}) is defined as

$$\text{diag} \left({C}_{1 \times N}\right) \left[r , c\right] = \left\{\begin{matrix}{C}_{1 \times N} \left[1 , c\right] , & \text{if} r = c \\ 0 , & \text{if} r \neq c\end{matrix}\right)$$

, and matrix D_{1×N} store intensity of each of the color-components that are transmitted by the conventional CFA pattern, which is intended to be optimized (D_{1×3} = [R 2G B] for example, in case of ideal 2×2 Bayer CFA pattern). Note that in a case where wavelength ranges of plural color-components are overlapping, actual maximum values of the light transmittances for an ideal color filter element that transmit the plural color-components are obtained after min-max normalization of sum of initially assumed light transmittances for the ideal color filter element, which is illustrated in more detail, by way of example, in paragraph [0024]. Depending on particular desired purpose,

$${\text{τ}}_{1 , 1}^{{c}_{1}} , ⋯ , {\text{τ}}_{a , b}^{{c}_{N}}$$

may be configured to achieve optimal tradeoff between image sensor low-light sensitivity (which is proportional to µ) and color depth of a demosaiced full-color image that is associated with raw image data captured by a color image sensor that is associated with P_{a×b}, under constraint condition that

$${\text{τ}}_{1 , 1}^{{c}_{1}} , ⋯ , {\text{τ}}_{a , b}^{{c}_{N}}$$

associated with maximum color depth are chosen for every value of the variable µ, wherein the color depth is positively correlated with

$${\prod }_{k = 1}^{N} {\text{σ}}_{k}$$

wherein σₖ is standard deviation of maximum values of light transmittances of color-component cₖ, for each of the ideal color filter elements, that is

$$\left\{{\text{τ}}_{i , j}^{{c}_{k}} : 1 \leq i \leq a , 1 \leq j \leq b\right\} .$$

Fortunately, any loss in color depth due to the optimization can be compensated by increasing sensor depth (or bit depth). A remarkable feature of above method is that each of the color-components c₁,...,c_{N} is partly sampled at plural pixel locations, thereby reducing color information loss in color-component images of c₁,...,c_{N} in the raw image data, that is inevitable in case of an undersampled raw digital color image data captured by a digital image sensor which includes a CFA that is associated with the conventional CFA pattern, wherein each of the color-components is sampled at single pixel location.

For simplicity and clarity, consider an explanatory illustration in which a 2 × 2 photosite group that is associated with a conventional RGB CFA pattern is given by

$$\left[\begin{matrix}\text{ζ} \left({C}_{1 \times 3}\right) & 0 \\ 0 & \text{ζ} \left({C}_{1 \times 3}\right)\end{matrix}\right] ⋅ \left[\begin{matrix}{F}_{1 , 1} & {F}_{1 , 2} \\ {F}_{2 , 1} & {F}_{2 , 2}\end{matrix}\right] = \left[\begin{matrix}{G}_{1 , 1} & {G}_{1 , 2} \\ {G}_{2 , 1} & {G}_{2 , 2}\end{matrix}\right]$$

, wherein

$${C}_{1 \times 3} = \left[\begin{matrix}{v}_{R} & {v}_{G} & {v}_{B}\end{matrix}\right] \text{and} {F}_{i , j} = \left[\begin{matrix}{\text{τ}}_{i , j}^{R} \\ {\text{τ}}_{i , j}^{G} \\ {\text{τ}}_{i , j}^{B}\end{matrix}\right] .$$

In (Bayer US3971065A), ideal 2×2 Bayer CFA pattern is configured as

$${F}_{1 , 2} = \left[\begin{matrix}1 \\ 0 \\ 0\end{matrix}\right] , {F}_{1 , 1} = {F}_{2 , 2} = \left[\begin{matrix}0 \\ 1 \\ 0\end{matrix}\right] , {F}_{2 , 1} = \left[\begin{matrix}0 \\ 0 \\ 1\end{matrix}\right]$$

, or equivalently s_{1,2} = v_{R}, s_{1,1} = s_{2,2} = v_{G}, s_{2,1} = v_{B} wherein s_{i,j} = G_{i,j}[1,1]. Therefore, amount of light intensity transmitted by the CFA pattern on underlying photodetector group is

$${\sum }_{i = 1}^{2} {\sum }_{j = 1}^{2} {s}_{i , j} = {v}_{R} + 2 {v}_{G} + {v}_{B} .$$

Consider next an alternative version P_{2×2} of the ideal 2×2 Bayer CFA pattern wherein ideal optical filter elements F_{1,1},...,F_{2,2} have ratios of maximum values of (overlapping) light transmittances of Red, Green and Blue (RGB) color-components (values are rounded off for simplicity) as follows:

$$\begin{matrix}{\text{τ}}_{1 , 2}^{R} : {\text{τ}}_{1 , 2}^{G} : {\text{τ}}_{1 , 2}^{B} = 4 / 5 : 1 : 3 / 5 , \\ {\text{τ}}_{1 , 1}^{R} : {\text{τ}}_{1 , 1}^{G} : {\text{τ}}_{1 , 1}^{B} = {\text{τ}}_{2 , 2}^{R} : {\text{τ}}_{2 , 2}^{G} : {\text{τ}}_{2 , 2}^{B} = 1 / 3 : 1 : 1 / 3 , \\ {\text{τ}}_{2 , 1}^{R} : {\text{τ}}_{2 , 1}^{G} : {\text{τ}}_{2 , 1}^{B} = 3 / 5 : 1 : 4 / 5 .\end{matrix}$$

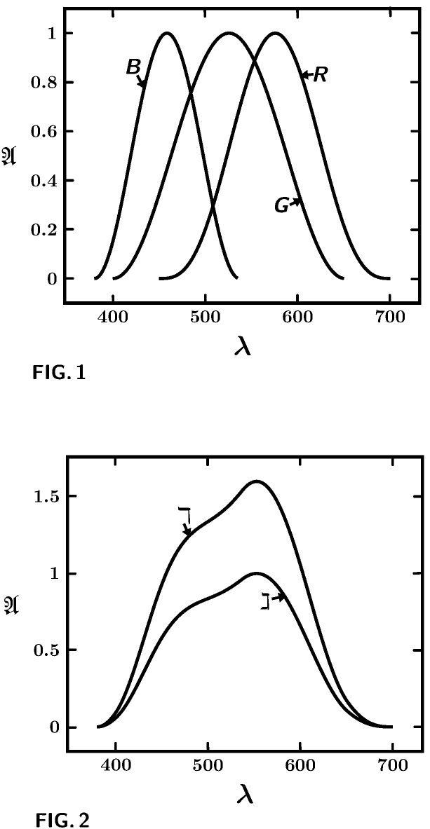

Let ℸ= [R G B]·(a·F_{1,2}), as shown in FIG. 2, be a tentative spectral transmittance curve of F_{1,2} which is a superimposition of light transmittances of the RGB color-components for F_{1,2} wherein initially assumed maximum values, that is

$$a ⋅ {F}_{1 , 2} = \left[\begin{matrix}4 / 5 \\ 1 \\ 3 / 5\end{matrix}\right]$$

wherein a∈R⁺, of the light transmittances are the same as their ratio that is specified in Equation (4), and wherein R, G and B are spectral transmittance curves of color filter elements forming ideal Bayer-pattern as shown in FIG. 1. Since maximum value of transmission characteristic of a color filter is equal to or lesser than 1, actual spectral transmission characteristic of F_{1,2}, defined as J = [R G B] ·F_{1,2}, is obtained by applying min-max normalization method to perform [0,1] normalization on ℸ, as shown in FIG. 2. Thus, actual maximum values of the light transmittances of F_{1,2} is given by formula:

$${F}_{1 , 2} = \frac{1}{a} \left[\begin{matrix}4 / 5 \\ 1 \\ 3 / 5\end{matrix}\right]$$

, wherein a = max ℸ is maximum value of ℸ. Therefore,

$${F}_{1 , 2} = \left[\begin{matrix}0.561 \\ 0.702 \\ 0.421\end{matrix}\right] .$$

Finally, the ideal absorptive/subtractive color filter F_{1,2} is manufactured so as to have a maximum value of 56.1% of light transmittance of Red color-component R, a maximum value of 70.2% of light transmittance of Green color-component G and a maximum value of 42.1% of light transmittance of Blue color-component B at a nearly vertical angle of incident light. The above operations may be performed iteratively for each F_{i,j} constituting P_{2×2} to finally obtain

$${F}_{1 , 2} = \left[\begin{matrix}0.561 \\ 0.702 \\ 0.421\end{matrix}\right] , {F}_{1 , 1} = {F}_{2 , 2} = \left[\begin{matrix}0.272 \\ 0.816 \\ 0.272\end{matrix}\right] , {F}_{2 , 1} = \left[\begin{matrix}0.375 \\ 0.625 \\ 0.5\end{matrix}\right]$$

In this case, light intensity transmitted by the CFA pattern in Equation (5) on underlying photodetector group is

$${\sum }_{i = 1}^{2} {\sum }_{j = 1}^{2} {s}_{i , j} = 1.48 {v}_{R} + 2.959 {v}_{G} + 1.465 {v}_{B}$$

that is equivalent to about 148% as much image sensor sensitivity as available in case of the conventional ideal Bayer filter pattern.

Let ζ(C_{1×3}) = [v_{R} v_{G} v_{B}] be solution to a raw image pattern R_{2×2} captured by an image sensor array that is associated with P_{2×2} as given in Equation (5), which is obtained by solving Equation (3) according to paragraph [0020]. Since

$$\begin{matrix}{\text{τ}}_{1 , 1}^{G} = max \left({\text{τ}}_{1 , 1}^{G} , {\text{τ}}_{1 , 2}^{G} , {\text{τ}}_{2 , 1}^{G} , {\text{τ}}_{2 , 2}^{G}\right) , & {\text{τ}}_{1 , 2}^{R} = max \left({\text{τ}}_{1 , 1}^{R} , {\text{τ}}_{1 , 2}^{R} , {\text{τ}}_{2 , 1}^{R} , {\text{τ}}_{2 , 2}^{R}\right) , \\ {\text{τ}}_{2 , 1}^{B} = max \left({\text{τ}}_{1 , 1}^{B} , {\text{τ}}_{1 , 2}^{B} , {\text{τ}}_{2 , 1}^{B} , {\text{τ}}_{2 , 2}^{B}\right) , & {\text{τ}}_{2 , 2}^{G} = max \left({\text{τ}}_{1 , 1}^{G} , {\text{τ}}_{1 , 2}^{G} , {\text{τ}}_{2 , 1}^{G} , {\text{τ}}_{2 , 2}^{G}\right)\end{matrix}$$

in _{2×2}, it follows from Equation (2) that one applies to each raw image pattern, that is in the form of R_{2×2}, in raw color image data captured by the image sensor array, the image transform

$${R}_{2 \times 2} = \left[\begin{matrix}\left[{v}_{G}\right] & \left[{v}_{R}\right] \\ \left[{v}_{B}\right] & \left[{v}_{G}\right]\end{matrix}\right]$$

to transform the raw color image data into raw Bayer-type image data so as to make it compatible with known color demosaicing algorithms that are used to demosaic raw Bayer-type image data (as discussed in Gunturk, B. K., et al.). The obtained raw Bayer-type image data is then demosaiced into a final full-color image by using any one of the color demosaicing algorithms. Note further that final RGB color values in ζ(C_{1×3}) are weighted averages of all pixel values in R_{2×2} prior to its transformation, and thus color accuracy in final full-color image is considerably better than when measured by Bayer image sensor array, wherein each color-component value is measured at a single image sensor pixel location, and then interpolated for neighboring pixels.

The invention has been described in detail with particular respect to implementations thereof, but it will be appreciated that variations and modifications can be effected within the spirit and scope of the invention. For example, a variety of sensors might be employed, including the sensors of CMOS or CCD imaging arrays. Moreover, color-sensitive elements for use in the invention may have inherent selective sensitivity or may incorporate filters either adjacent to or removed from a broad-wavelength-range sensor, which filters selectively limit the range of sensitivity for individual sensors. Also, while the invention is cast in the environment of camera utilizations, it has other uses, for example, in connection with color printing devices and color display devices.

I claim:

1. A method for designing color filter arrays (CFAs), each color filter array comprising:
a plurality of tiled side-by-side identical minimal repeating units, wherein each of said minimal repeating units comprises:
wavelength selective color filter elements (optical filters), each of which is permanently superposed in one-to-one registry on a physically separate light-sensitive element (photodetector) in an array of solid state broad spectrum photodetectors so as to form a photosite group of a color image sensor of a camera module;
wherein said color filter elements are of types so that each of said color filter elements transmits at least one of color-components of an additive (or subtractive) color-space, each of said color-components is transmitted by at least one of said color filter elements and said types of color filter elements are at least equal to number of said color-components in total;
wherein at least one type of color filter elements is adapted to transmit an additive (or subtractive) mixture of plural color-components of said color-space, and wherein spectral transmission characteristic of said type of color filter elements is a superimposition of (perhaps overlapping) light transmittances of said plural color-components for said type of color filter elements so as to store sum of (perhaps fractional) values of said plural color-components in pixel location(s) of a raw image pattern, wherein said pixel location(s) is/are associated with said type of color filter elements and said photosite group is configured to electronically capture said raw image pattern; and
wherein at least one of type(s) of color filter elements, that is/are adapted to transmit an additive (or subtractive) mixture of plural color-components of said color-space, has at least two of (non-zero) maximum values of light transmittances of said plural color-components that are distinct so as to transmit unequal amounts of at least two of said plural color-components.

2. A color conversion method, for reconstructing raw image data that is associated with a color filter array according to claim 1, wherein each pixel of said raw image data has a raw grayscale value of a color-channel associated with a color filter element that corresponds to said pixel, to generate a mosaiced-image that is separated into color-component images of color-components of a color-space as defined in claim 1 so as to demosaic said mosaiced-image into a full-color image wherein pixels have values in all color-channels of said color-space, by using any known demosaicing technique (for example, linear interpolation, bilinear, etc.).

3. An optimization method to obtain spectral transmission characteristics of different types of color filter elements forming a color filter array according to claim 1, wherein said spectral transmission characteristics are associated with optimal tradeoff among low-light sensitivity of a color image sensor, effective resolutions of color-component images of color-components of a color-space as defined in claim 1 and color depth of a demosaiced full-color image, that are associated with said color filter array.
